(19) United States
(12) Patent Application Publication
(10) Pub. No.: US 2011/0157931 A1
(43) Pub. Date: Jun. 30, 2011

(54) RESONANT POWER CONVERTER

(75) Inventor: Shinji SATO, Niiza-shi (JP)

(73) Assignee: Sanken Electric Co., Ltd., Niiza-shi (JP)

(21) Appl. No.: 12/949,379

(22) Filed: Nov. 18, 2010

(30) Foreign Application Priority Data
Dec. 28, 2009 (JP) 2009-297867

(51) Int. Cl. H02H 7/122

(52) U.S. Cl. 363/56.02

(57) ABSTRACT

The present invention provides a resonant power converter including: a first switch circuit in which multiple normally-off switches Q1 to Q4 to which resonant capacitors 6a to 6d are connected in parallel respectively are connected in a single-phase or three-phase bridge configuration; and a second switch circuit connected to a DC power supply 1 and the first switch circuit, including a resonant switch Q7 and a resonant reactor 5 which forms a resonant circuit together with each the resonant capacitor in the first switch circuit, and configured to provide zero voltage switching of the normally-off switches in the first switch circuit. The resonant switch in the second switch circuit is a normally-on switch, short-circuiting units 12a to 12f are connected to the normally-off switches in the first switch circuit and the normally-on switch in the second switch circuit, respectively, the short-circuiting units each configured to cause a short circuit between a control terminal and one main terminal of the corresponding one of the normally-off switches and the normally-on switch, and control is made on the short-circuiting units so that the short-circuiting units do not operate normally but operates in case of emergency.

### TECHNICAL FIELD

The present invention relates to a resonant power converter configured to reduce a load on a power semiconductor switch formed as a main component, and particularly to a technique to shut down a resonant power converter rapidly and reliably in case of emergency.

### BACKGROUND ART

A power converter converts AC power or DC power into AC power or DC power of different levels by using a switching operation of a power semiconductor switch. Such a power converter is used, for example, for an uninterruptible power supply system, an inverter for driving a motor, a communication DC power supply, or the like.

Switching loss of the power semiconductor switch causes deterioration in power conversion efficiency and switching noise of the power semiconductor switch causes malfunctions of the power semiconductor switch itself or of other devices. In view of the above, a resonant power converter which reduces the switching loss or the switching noise is used.

FIG. 1 is a circuit configuration diagram showing an example of a conventional resonant power converter described in Japanese Patent Application Publication No. 2000-262066. In FIG. 1, the positive electrode of a DC power supply 1 is connected to a positive DC terminal 3a while the negative electrode of the DC power supply 1 is connected to a negative DC terminal 3b. Between the positive DC terminal 3a and the negative DC terminal 3b, a series circuit including an insulated gate bipolar transistor (IGBT) Q6, a resonant reactor 5, an IGBT Q5, and a capacitor 7 is connected. This series circuit constitutes a second switch circuit 30.

A first series circuit is connected to both ends of a series circuit including the resonant reactor 5, the IGBT Q5, and the capacitor 7. The first series circuit includes a first parallel circuit and a second parallel circuit. The first parallel circuit includes an IGBT Q1, a resonant capacitor 6a, and a diode D1 while the second parallel circuit includes an IGBT Q2, a resonant capacitor 6b, and a diode D2.

In addition, a second series circuit is connected to both ends of the series circuit including the resonant reactor 5, the IGBT Q5, and the capacitor 7. The second series circuit includes a third parallel circuit and a fourth parallel circuit. The third parallel circuit includes an IGBT Q3, a resonant capacitor 6c, and a diode D3 while the fourth parallel circuit includes an IGBT Q4, a resonant capacitor 6d, and a diode D4.

A node of the first parallel circuit and the second parallel circuit is connected to one end of a load 2 via an AC terminal 4a while a node of the third parallel circuit and the fourth parallel circuit is connected to the other end of the load 2 via an AC terminal 4b. The first to fourth parallel circuits constitute a first switch circuit 20.

Between the gates and the emitters of the IGBTs Q1 to Q6, gate drive circuits 10a to 10f are connected via resistors 11a to 11f. The gate drive circuits 10a to 10f drive the IGBTs Q1 to Q6 on and off by applying gate signals to the IGBTs Q1 to Q6, respectively.

According to the conventional resonant power converter which is shown in FIG. 1 and configured in this manner, the IGBTs Q1 to Q6 are turned on when the gate drive circuits 10a to 10f apply gate signals of +15 V, for example, between the gates and the emitters of the IGBTs Q1 to Q6, while the IGBTs Q1 to Q6 are turned off when the gate drive circuits 10a to 10f apply 0 V or negative voltage, for example, between the gates and the emitters of the IGBTs Q1 to Q6. In other words, the IGBTs Q1 to Q6 are normally-off switches.

The gate drive circuits 10a to 10f perform on-off control on the IGBTs Q1 to Q6 based on a control signal from an unillustrated control circuit. Thereby, DC power from the DC power supply 1 is converted into AC power, and the AC power is then supplied to the load 2.

In this case, the IGBTs Q1 to Q4 and Q6 perform zero voltage switching by the resonant operation between the resonant reactor 5 and the resonant capacitors 6a to 6d and 6f connected in parallel to the respective IGBTs Q1 to Q4 and Q6. Meanwhile, the IGBT Q5 performs zero current switching by the resonant operation between the resonant capacitor 6f and the resonant reactor 5 connected in series with the IGBT Q5. Thus, the switching loss and the switching noise of the IGBTs Q1 to Q6 are reduced.

However, in the resonant power converter as shown in FIG. 1, if the IGBT Q5 is turned off forcibly while a current flows through the resonant reactor 5, the IGBT Q5 may be broken since the energy of the resonant reactor 5 flows into the IGBT Q5.

Further, if the IGBTs Q1 to Q4 and Q6 are turned on while the resonant capacitors 6a to 6d and 6f have a voltage, the IGBTs Q1 to Q4 and Q6 may be broken since the energy of the resonant capacitors 6a to 6d and 6f flows into the respective IGBTs Q1 to Q4 and Q6.

For this reason, it is preferable to turn on or turn off the IGBTs Q1 to Q6 at any given timing by providing a power absorption circuit, such as a snubber circuit, which absorbs the energy of the resonant reactor 5 or of the resonant capacitors 6a to 6d and 6f.

In addition, there is a need to shut down the converter rapidly in case of emergency, such as in a case where a microcomputer constituting the control circuit malfunctions or runs away or where there is an abnormality in the power source of the control circuit. In case of emergency, the conventional converter uses both an OFF signal which turns off the IGBTs Q1 to Q4 and Q6 and an ON signal which turns on the IGBT Q5. In other words, the gate drive circuits 10a to 10f are complicated since the circuit configuration for the gate drive circuits 10a to 10d and 10f differs from the circuit configuration for the gate drive circuit 10e.

### SUMMARY OF INVENTION

An object of the present invention is to provide a resonant power converter which can be shut down rapidly and reliably in case of emergency with a simple circuit.

The present invention provides a resonant power converter including: a first switch circuit in which multiple normally-off switches to each of which a resonant capacitor is connected in parallel are connected in a single-phase or three-phase bridge configuration; and a second switch circuit connected to a DC power supply and the first switch circuit, including a resonant switch and a resonant reactor which forms a resonant circuit together with each the resonant capacitor in the first switch circuit, and configured to provide zero voltage switching of the normally-off switches in the first switch circuit, the resonant power converter configured to convert DC power from the DC power supply into AC power in the first switch circuit and to output the AC power. The resonant switch in the second switch circuit is a normally-on switch, a short-circuiting unit is connected to each of the normally-off switches in the first switch circuit and the normally-on switch in the second switch circuit, the short-circuiting unit configured to cause a short circuit between a control terminal and one main terminal of each of the normally-off switches and the normally-on switch, and control is made on the short-circuiting units so that the short-circuiting units do not operate normally but operates in case of emergency.

### BRIEF DESCRIPTION OF DRAWINGS

FIG. 1 is a circuit configuration diagram showing an example of a conventional resonant power converter.

FIG. 2 is a circuit configuration diagram showing a resonant power converter according to a first embodiment.

FIG. 3 is a circuit configuration diagram showing a resonant power converter according to a second embodiment.

### DESCRIPTION OF EMBODIMENTS

Hereinbelow, embodiments of a resonant power converter according to the present invention will be described in detail with reference to the drawings.

### First Embodiment

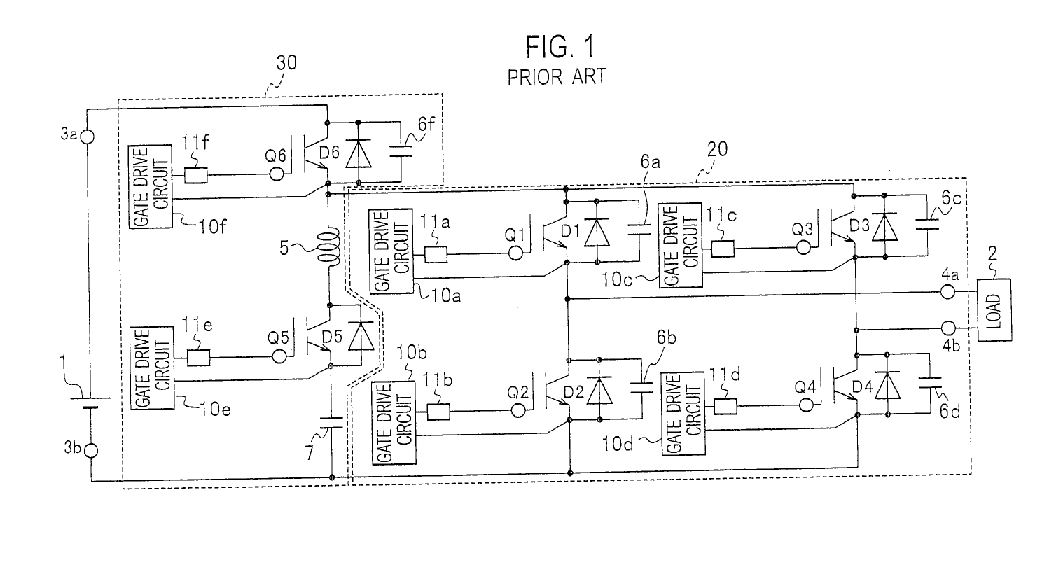

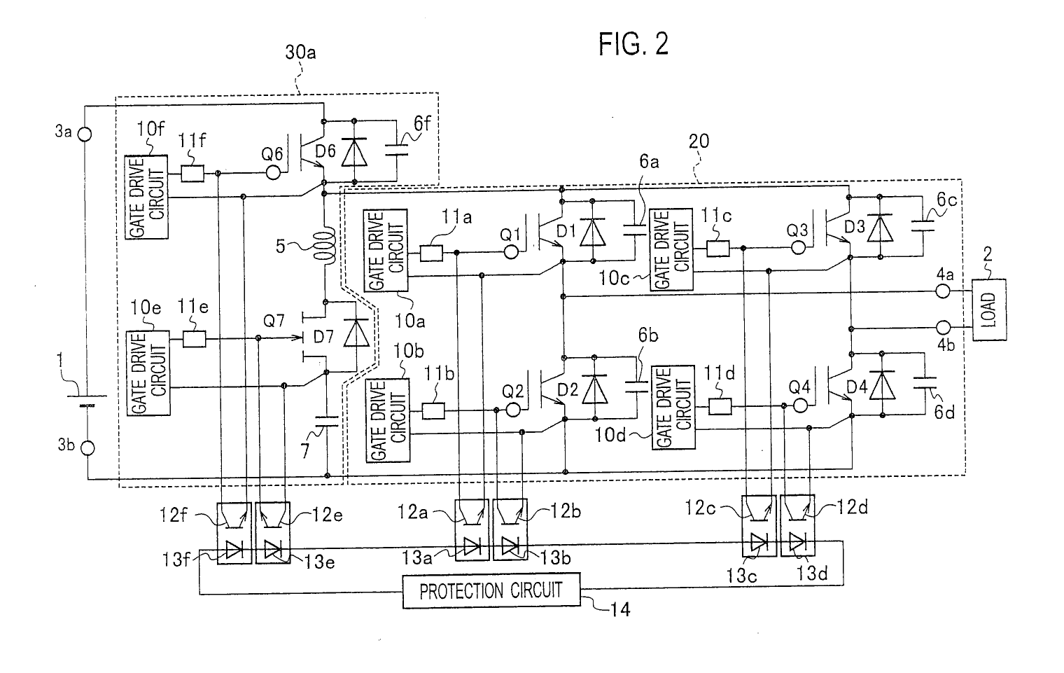

FIG. 2 is a circuit configuration diagram showing a resonant power converter according to a first embodiment. The resonant power converter according to the first embodiment shown in FIG. 2 is different from the resonant power converter shown in FIG. 1, and is characterized in that a normally-on switch Q7 (resonant switch) is used instead of the IGBT Q5 and that a protection circuit 14 (short-circuiting unit) and photo couplers including photo transistors 12a to 12f and photodiodes 13a to 13f are provided. IGBTs Q1 to Q4 and Q6 are formed of the normally-off switches.

Note that other configurations of the resonant power converter shown in FIG. 2 are the same as those of the resonant power converter shown in FIG. 1. Thus, the same reference numerals are given to the same components, and the description thereof will be omitted.

The normally-on switch Q7 is made of a wide bandgap semiconductor, such as silicon carbide (SiC) or gallium nitride (GaN). The normally-on switch Q7 is turned on when the gate-source voltage is 0 V. In this respect, the normally-on switch Q7 is turned on with the gate-source voltage of +15 V and is turned off with the gate-source voltage of −10 V. Fabricating a normally-on device from such a wide bandgap semiconductor is easier than from an Si device.

Gate drive circuits 10a to 10f output AC power to AC terminals 4a and 4b by performing on/off control on the normally-on switch Q7 and the IGBTs Q1 to Q4 and Q6.

The collectors of the photo transistors 12a to 12d are connected to the gates of the respective IGBTs Q1 to Q4 and respective resistors 11a to 11d, the collector of the photo transistor 12f is connected to the gate of the IGBT Q6 and a resistor 11f, and the collector of the photo transistor 12e is connected to the source of the normally-on switch Q7, the anode of a diode D7, and a capacitor 7.

The emitters of the photo transistors 12a to 12d are connected to the emitters of the IGBTs Q1 to Q4, the anodes of diodes D1 to D4, and resonant capacitors 6a to 6d, respectively. The emitter of the photo transistor 12f is connected to the emitter of the IGBT Q6, the anode of a diode D6, and a resonant capacitor 6f. The emitter of the photo transistor 12e is connected to the gate of the normally-on switch Q7 and a resistor 11e.

To both ends of the protection circuit 14, a series circuit including the photodiodes 13a to 13f are connected. In case of emergency, the protection circuit 14 causes a short circuit between the gate and the emitter of each of the IGBTs Q1 to Q4 and Q6 and between the gate (control terminal) and the source (one main terminal) of the normally-on switch Q7 by feeding a current through the series circuit including the photodiodes 13a to 13f.

Next, an operation of the resonant power converter according to the first embodiment configured in this manner will be described.

Firstly, in a normal state, the gate drive circuits 10a to 10f apply voltages (+15 V and −10V) to the gate of the normally-on switch Q7 and to the gates of the IGBTs Q1 to Q4 and Q6, respectively, and the switches are thus turned on and off to output AC power to the AC terminals 4a and 4b.

In a case where an abnormality occurs in any of the gate drive circuits 10a to 10f or an unillustrated control circuit, the protection circuit 14 applies a protection signal to the series circuit including the photodiodes 13a to 13f. Accordingly, the photodiodes 13a to 13f emit light, a current flows through the photo transistors 12a to 12f, and thus short circuits are caused between the gates and the emitters of the IGBTs Q1 to Q4 and Q6 and between the gate and the source of the normally-on switch Q7.

Thus, the IGBTs Q1 to Q4 and Q6 are turned off while the normally-on switch Q7 is turned on. In this manner, in case of emergency, the IGBTs Q1 to Q4 and Q6 are turned off while the normally-on switch Q7 is turned on with a single protection signal from the protection circuit 14. In other words, it is possible to turn on and off the switches Q1 to Q4, Q6, and Q7 reliably, and thus to shut down the resonant power converter rapidly and reliably in case of emergency.

### Second Embodiment

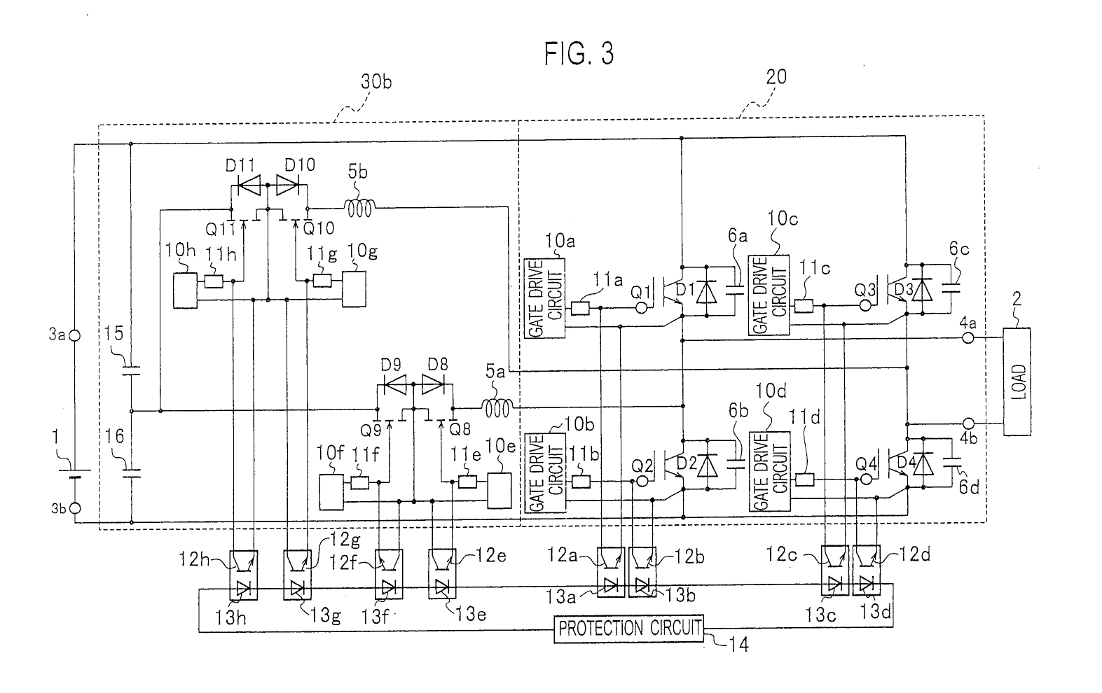

FIG. 3 is a circuit configuration diagram showing a resonant power converter according to a second embodiment. The resonant power converter according to the second embodiment shown in FIG. 3 is characterized in that the present invention is applied to an auxiliary resonant commutated pole inverter.

In FIG. 3, the positive electrode of a DC power supply 1 is connected to a positive DC terminal 3a while the negative electrode of the DC power supply 1 is connected to a negative DC terminal 3b. Between the positive DC terminal 3a and the negative DC terminal 3b, a series circuit including a capacitor 15 and a capacitor 16 is connected. The capacitor 16 has the same capacitance as the capacitor 15. At a node of the capacitor 15 and the capacitor 16, a voltage which is half the voltage of the DC power supply 1 is generated.

To both ends of a series circuit including the capacitor 15 and the capacitor 16, a first series circuit including a first parallel circuit and a second parallel circuit is connected. The first parallel circuit includes an IGBT Q1, a resonant capacitor 6a, and a diode D1 while the second parallel circuit includes an IGBT Q2, a resonant capacitor 6b, and a diode D2. In addition, to both ends of the series circuit including the capacitor 15 and the capacitor 16, a second series circuit including a third parallel circuit and a fourth parallel circuit is connected. The third parallel circuit includes an IGBT Q3, a resonant capacitor 6c, and a diode D3 while the fourth parallel circuit includes an IGBT Q4, a resonant capacitor 6d, and a diode D4.

A node of the first parallel circuit and the second parallel circuit is connected to one end of a load 2 via an AC terminal 4a, while a node of the third parallel circuit and the fourth parallel circuit is connected to the other end of the load 2 via an AC terminal 4b. Between a node of the first parallel circuit and the second parallel circuit and the node of the capacitor 15 and the capacitor 16, a resonant reactor 5a, a normally-on switch Q8, and a normally-on switch Q9 are connected.

The normally-on switches Q8 and Q9 constitute a bidirectional switch (resonant switch). The normally-on switches Q8 and Q9 are made of a wide bandgap semiconductor such as Sic or GaN. Instead, for example, GaN High Electron Mobility Transistor (HEMT) may be employed as a bidirectional switch.

The drain of the normally-on switch Q9 is connected to the cathode of a diode D9 and the node of the capacitor 15 and the capacitor 16.

The source of the normally-on switch Q9 is connected to the anode of the diode D9, the anode of a diode D8, the source of the normally-on switch Q8, and one end of each of gate drive circuits 10e and 10f. The drain of the normally-on switch Q8 is connected to the cathode of the diode D8 and one end of the resonant reactor 5a.

The gate of the normally-on switch Q8 is connected to the other end of the gate drive circuit 10e via a resistor 11e while the gate of the normally-on switch Q9 is connected to the other end of the gate drive circuit 10f via a resistor 11f.

The emitter and the collector of a photo transistor 12e are connected to the gate and the source of the normally-on switch Q8, respectively, while the emitter and the collector of a photo transistor 12f are connected to the gate and the source of the normally-on switch Q9.

Between a node of the third parallel circuit and the fourth parallel circuit and the node of the capacitor 15 and the capacitor 16, a resonant reactor 5b, a normally-on switch Q10, and a normally-on switch Q11 are connected.

The normally-on switches Q10 and Q11 constitute a bidirectional switch (resonant switch). The normally-on switches Q10 and Q11 are made of a wide bandgap semiconductor such as Sic or GaN. Instead, for example, GaN High Electron Mobility Transistor (HEMT) may be employed as a bidirectional switch.

The drain of the normally-on switch Q11 is connected to the cathode of a diode D11 and the node of the capacitor 15 and the capacitor 16.

The source of the normally-on switch Q11 is connected to the anode of the diode D11, the anode of a diode D10, the source of the normally-on switch Q10, and one end of each of gate drive circuits 10g and 10h. The drain of the normally-on switch Q10 is connected to the cathode of the diode D10 and one end of the resonant reactor 5b.

The gate of the normally-on switch Q10 is connected to the other end of the gate drive circuit 10g via a resistor 11g while the gate of the normally-on switch Q11 is connected to the other end of the gate drive circuit 10h via a resistor 11h.

The emitter and the collector of a photo transistor 12g are connected to the gate and the source of the normally-on switch Q10, respectively, while the emitter and the collector of a photo transistor 12h are connected to the gate and the source of the normally-on switch Q11. Photodiodes 13g and 13h are connected in series with photodiodes 13a to 13f. The photodiode 13g and the photo transistor 12g constitute a photo coupler, and the photodiode 13h and the photo transistor 12h constitute a photo coupler.

Also in the resonant power converter according to the second embodiment configured in this manner, the IGBTs Q1 to Q4 are formed of the normally-off switches while the normally-on switches Q8 to Q11 are formed of the normally-on switches. For this reason, in case of emergency, the IGBTs Q1 to Q4 can be turned off while the normally-on switches Q8 to Q11 can be turned on with a single protection signal from the protection circuit 14. In other words, it is possible to turn on and off the switches Q1 to Q4 and Q8 to Q11 reliably, and thus to shut down the resonant power converter rapidly and reliably in case of emergency.

Subsequently, description will be given of a resonant operation between the IGBTs Q1 and Q2 of the resonant power converter according to the second embodiment. The gate drive circuits 10a to 10f turn on the normally-on switches Q8 and Q9 simultaneously during a dead time period of the IGBTs Q1 and Q2 (during a period in which the IGBTs Q1 and Q2 are both turned off).

While the IGBT Q4 is on but the IGBTs Q1 and Q2 are off, a current flows in a path of 4a and 4b→Q4→Q2→4a and 4b. Since the current flows through the diode D2 corresponding to the IGBT Q2, the collector-emitter voltage of the IGBT Q2 becomes zero. For this reason, when the IGBT Q1 is turned on, a DC voltage VDC from the DC power supply 1 is applied between the collector and the emitter of the IGBT Q1, and thus switching loss occurs.

In order to prevent the switching loss from occurring in the IGBT Q1, the collector-emitter voltage of the IGBT Q1 is set to zero during the dead time period immediately before switching of the IGBT Q1.

During the dead time period of the IGBTs Q1 and Q2, the normally-on switches Q8 and Q9 are turned on simultaneously. At this time, no current flows through the resonant reactor 5a, resulting in zero current switching of the normally-on switches Q8 and Q9.

When the potential of the negative electrode of the AC power supply 1 is set as a standard, the potential at the node of the capacitor 15 and the capacitor 16 is half the VDC and the potential at the node of the IGBTs Q1 and Q2 is zero, and thus the voltage applied to the resonant reactor 5a is half the VDC. Then, the current flowing through the resonant reactor 5a increases.

At the time when the current in the resonant reactor 5a reaches the level of the current flowing through the AC terminals 4a and 4b, resonance occurs between the resonant reactor 5a and the capacitors 6a and 6b. In this event, charges are discharged from the capacitor 6a connected in parallel to the IGBT Q1 and the charges flow into the capacitor 6b connected in parallel to the IGBT Q2.

At the time when the resonance is completed, the potential at the node of the IGBTs Q1 and Q2 becomes equal to the VDC. For this reason, zero voltage switching (soft switching) of the IGBT Q1 can be achieved by turning on the IGBT Q1 at this time.

Since the potential at the node of the IGBTs Q1 and Q2 is equal to the VDC once the IGBT Q1 is turned on, the resonant current decreases thereafter. By turning off the normally-on switches Q8 and Q9 at the time when the current in the resonant reactor 5a reaches zero, the loss of the normally-on switches Q8 and Q9 can be also reduced.

While the IGBT Q1 is on, a current flows in a path of 4a and 4b→Q4→1→Q1→4a and 4b.

When the IGBT Q1 is turned off in this state, charges are discharged from the resonant capacitor 6b while charges are increased in the resonant capacitor 6a. At this time, since only the resonant capacitor 6a is connected in parallel to the IGBT Q1, no switching loss occurs. For this reason, soft switching can be achieved in both the turning-on and the turning-off of the IGBT Q1, leading to no switching loss and achievement of high efficiency. The same applies to the IGBTs Q3 and Q4.

Note that the present invention is not limited to the resonant power converters according to the first and second embodiments. The resonant power converters according to the first and second embodiments are described using a DC/AC power converter which converts DC power from the DC power supply 1 into single-phase AC power and outputs the AC power to the load 2 through the AC terminals 4a and 4b. However, the present invention is also applicable to a DC/AC power converter which converts DC power from the DC power supply 1 into three-phase AC power and outputs the AC power to a load through AC terminals.

As has been described, according to the present invention, the short-circuiting unit is connected to each of the normally-off switches in the first switch circuit and the normally-on switch(es) in the second switch circuit, the short-circuiting unit configured to cause a short circuit between a control terminal and one main terminal of each of the normally-off switches and the normally-on switch(es). Accordingly, in case of emergency, the normally-off switches in the first switch circuit can be turned off while the normally-on switches in the second switch circuit can be turned on with a single signal.

### INDUSTRIAL APPLICABILITY

The present invention is applicable to an uninterruptible power supply, an inverter for driving a motor, a communication DC power supply, or the like.

What is claimed is:

1. A resonant power converter comprising:
a first switch circuit in which a plurality of normally-off switches to each of which a resonant capacitor is connected in parallel are connected in a single-phase or three-phase bridge configuration; and
a second switch circuit connected to a DC power supply and the first switch circuit, including a resonant switch and a resonant reactor which forms a resonant circuit together with each the resonant capacitor in the first switch circuit, and configured to provide zero voltage switching of the normally-off switches in the first switch circuit,
the resonant power converter configured to convert DC power from the DC power supply into AC power in the first switch circuit and to output the AC power, wherein
the resonant switch in the second switch circuit is a normally-on switch,
a short-circuiting unit is connected to each of the normally-off switches in the first switch circuit and the normally-on switch in the second switch circuit, the short-circuiting unit configured to cause a short circuit between a control terminal and one main terminal of each of the normally-off switches and the normally-on switch, and
control is made on the short-circuiting units so that the short-circuiting units do not operate normally but operates in case of emergency.

2. The resonant power converter according to claim 1, wherein the normally-on switch is made of a wide bandgap semiconductor.
